(19) United States
(12) Patent Application Publication
(10) Pub. No.: US 2015/0117231 A1
(43) Pub. Date: Apr. 30, 2015

(54) INTER FREQUENCY MEASUREMENT SCHEDULING IN DISCONTINUOUS RECEPTION (DRX) MODE

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/065,358

(22) Filed: Oct. 28, 2013

(51) Int. Cl. H04W 24/10; H04W 76/04

(52) U.S. Cl. CPC H04W 24/10; H04W 76/048
USPC 370/252

(57) ABSTRACT

A user equipment (UE) avoids or reduces delay associated with measuring preferred neighbor cells by scheduling inter frequency measurements based on network indicated offset values provided by a network. In some instances, the UE performs measurements when the UE wakes up from a sleep mode. The UE schedules measurement of a neighbor cell with a lower offset value more frequently or earlier. The offset value can be a Qoffset value.

### BACKGROUND

1. Field

Aspects of the present disclosure relate generally to wireless communication systems, and more particularly, to inter frequency measurement scheduling while a mobile device is in a discontinuous reception (DRX) mode.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes scheduling inter frequency measurements based on a network indicated offset value of neighbor cells.

According to another aspect of the present disclosure, an apparatus for wireless communication includes means for scheduling inter frequency measurements based on a network indicated offset value of neighbor cells. The apparatus may also include means for performing inter frequency measurements based on the scheduling.

According to one aspect of the present disclosure, a computer program product for wireless communication in a wireless network includes a computer readable medium having non-transitory program code recorded thereon. The program code includes program code to schedule inter frequency measurements based at least in part on a network indicated offset value of neighbor cells.

According to one aspect of the present disclosure, an apparatus for wireless communication includes a memory and a processor(s) coupled to the memory. The processor(s) is configured to schedule inter frequency measurements based at least in part on a network indicated offset value of neighbor cells.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE 350 in a telecommunications system.

FIG. 4 illustrates a geographical area with coverage from three radio access technologies according to one aspect of the present disclosure.

FIG. 5 illustrates an inter frequency measurement and decoding implementation of a serving cell/radio access technology during a discontinuous receive (DRX) mode or cycle.

FIG. 6 is a block diagram illustrating an inter frequency measurement method for discontinuous reception mode according to one aspect of the present disclosure.

FIG. 7 is a diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

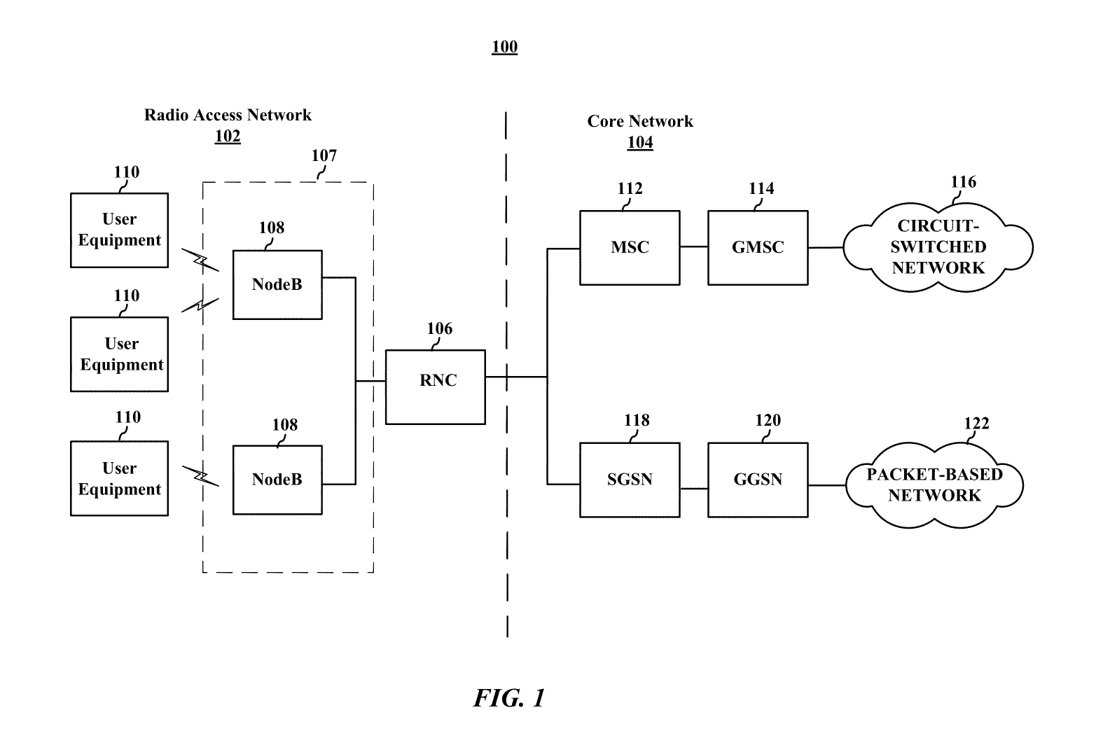

Turning now to FIG. 1, a block diagram is shown illustrating an example of a telecommunications system 90. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

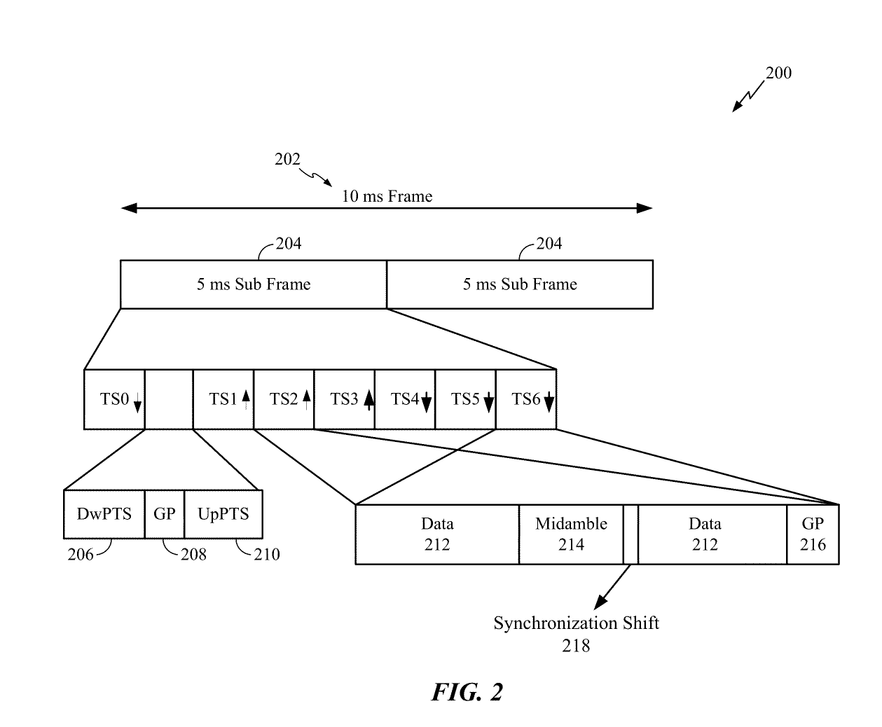

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

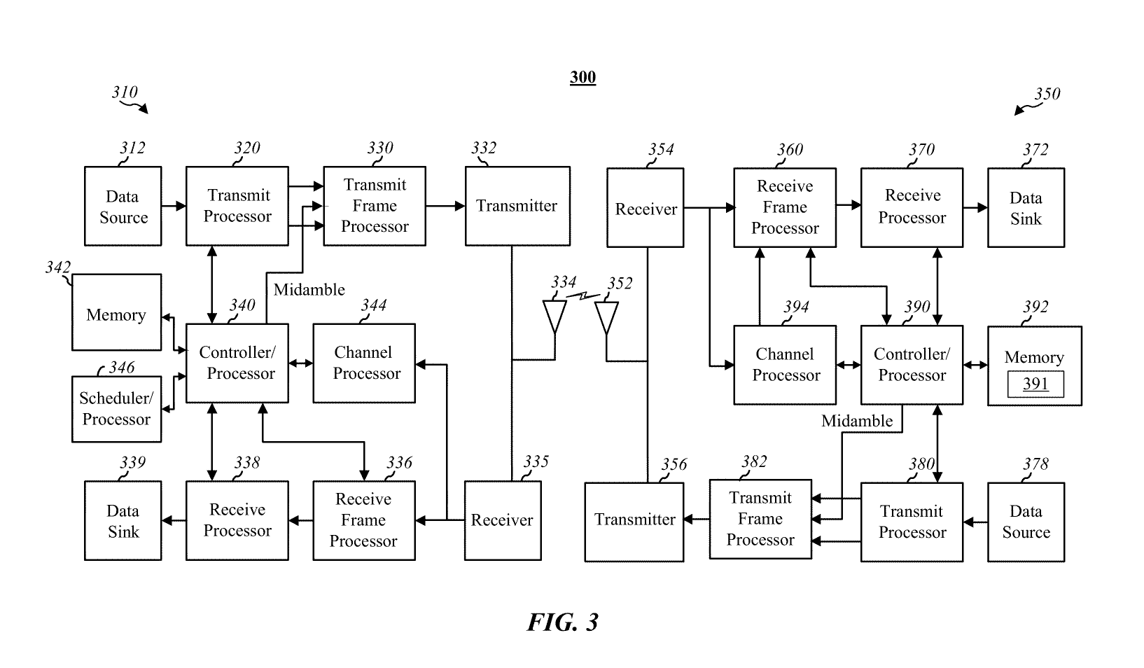

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

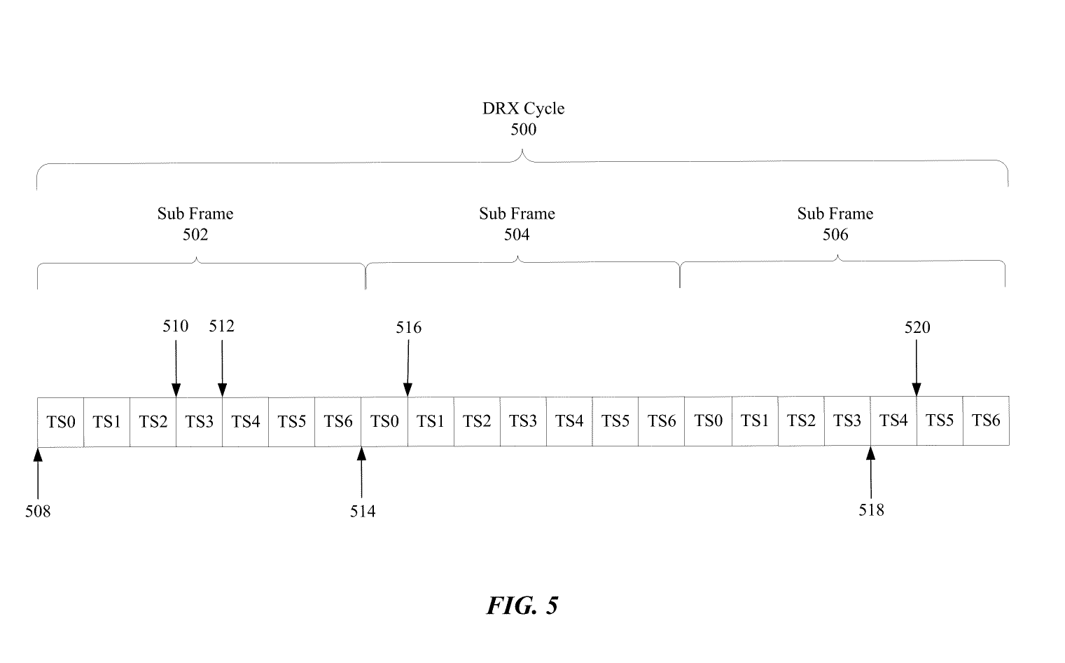

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The processor 340/390 and/or other processors and modules at the node B 310/UE 350 may perform or direct the execution of the functional blocks illustrated in FIG. 5. The computer readable media of memories 342 and 392 may store data and software for the node B 310 and the UE 350, respectively. For example, the memory 392 of the UE 350 may store an inter frequency measurement module 391 which, when executed by the controller/processor 390, configures the UE 350 for scheduling inter frequency measurements based at least in part on a network indicated offset value of neighbor cells. A scheduler/processor 346 at the node B 310 may be used to allocate resources to the UEs and schedule downlink and/or uplink transmissions for the UEs.

Deployment of a TD-SCDMA network may not provide complete geographic coverage in certain areas during the migration, e.g., from 2G to 3G or from 3G to 4G Radio Access Technologies (RATs). In areas where TD-SCDMA networks are deployed, other networks (such as WCDMA and Global System for Mobile Communications (GSM)) may also have a geographical presence.

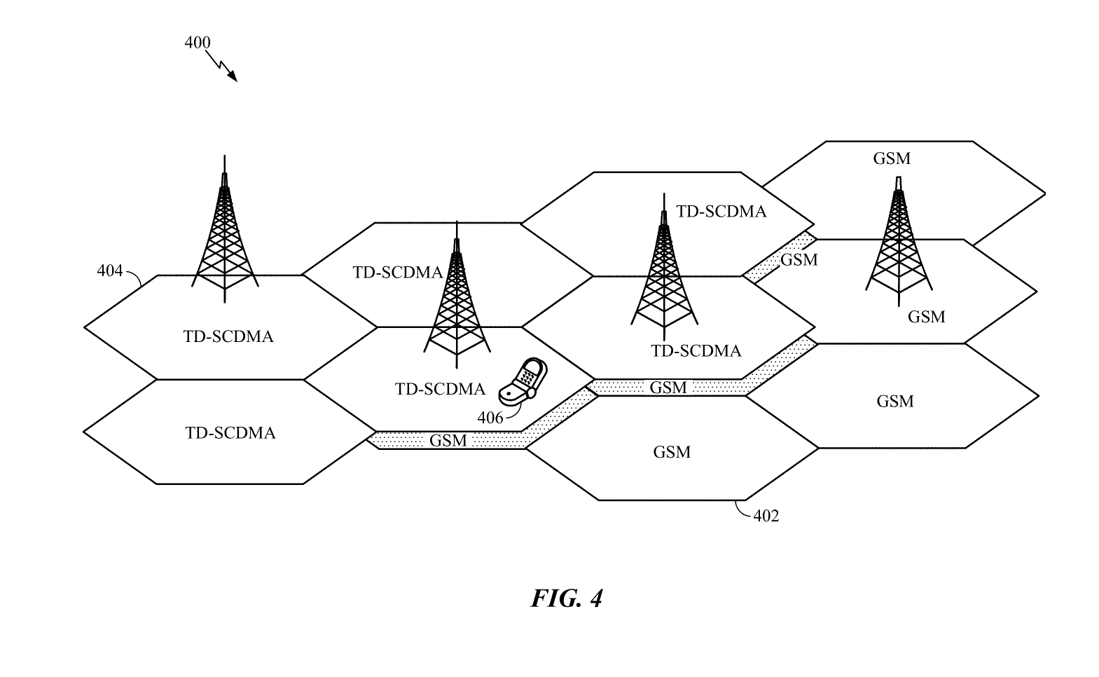

FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

The handover or cell reselection may be performed when the UE moves from a coverage area of a TD-SCDMA cell to the coverage area of a GSM cell, or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Other radio access technologies, such as a wireless local area network (WLAN) or WiFi may also be accessed by a user equipment (UE) in addition to cellular networks such as TD-SCDMA or GSM. For the UE to determine nearby WiFi access points (APs), the UE scans available WiFi channels to identify/detect if any WiFi networks exist in the vicinity of the UE. In one configuration, the UE may use TD-SCDMA reception/transmission gaps to switch to the WiFi network to scan the WiFi channels.

### Inter Frequency Measurement Scheduling in Discontinuous Reception (DRX) Mode

Aspects of the present disclosure avoid or reduce delay associated with measuring preferred neighbor cells by a UE. In one aspect, a UE schedules inter frequency measurements based on Qoffset values when the inter frequency neighbor cells have different Qoffset values. Scheduling inter frequency measurements based on the Qoffset values avoids or reduces delay associated with measuring preferred neighbor cells by a UE.

During wireless communication, user equipments (UEs) may be sporadically active and may remain idle for significant periods of time when no call is in progress. However, to ensure that any message directed to the UE is received, the UE periodically monitors the communication channel for messages (e.g., paging messages or signals transmitted by a base station), even while the UE is idle. The messages may include those for alerting the UE to the presence of an incoming call, those for updating system parameters in the UE, and/or instructions for measuring signals of neighboring base stations (i.e., inter RAT measurements or inter frequency measurements).

To reduce power consumption in a UE operating in idle mode, the UE may periodically enter an active state during which it may receive messages on a paging channel from the base stations with which it has previously established communication. The paging channel may be divided into numbered frames (e.g., frames 0 through 1023) and the UE may be assigned one or more frames by the base stations. Thereafter, the UE may awaken from an inactive state prior to its assigned frame, monitor the paging channels for messages, and revert to the inactive state if additional communication is not desired. Thus, the UE monitors paging messages from the base station informing the UE of possible incoming transmissions. In the time period between successive active states, the UE is in the inactive state and the base station does not send any messages to the UE. The time between two consecutive paging message is called a discontinuous receive (DRX) cycle. In the inactive state, as much circuitry as possible may be powered down to conserve power.

During wireless communication, UEs may desire to measure communication signals of neighboring base stations. The measurement may be an inter frequency measurement of a same or different RAT. Some of the measurements include received signal code power (RSCP) for a primary common control physical channel (P-CCPCH) of an inter frequency neighbor. The inter frequency measurements may be performed during a wakeup duration when the UE is in a discontinuous reception (DRX) mode, such as idle mode, physical channel (PCH), forward access channel (FACH) and other modes. The inter frequency measurements may be performed in the discontinuous receive (DRX) mode after monitoring the paging channel. Such inter frequency measurements may occur at specified time periods, during certain situations or in response to conditions that trigger the inter frequency measurements. The UE may perform inter frequency measurements of other radio access technologies (e.g., TD-SCDMA or GSM) supported by a neighboring base station when a UE receives a neighbor list message indicating the nearby RATs.

During idle mode, a UE may continue to consume power to perform inter frequency measurements. Many UEs are portable and powered by an internal battery. The inter frequency measurement power consumption by the UE in the idle mode decreases the available battery resources. As a result, it is may be desirable to reduce power consumption in the UE in the idle state to increase battery life. In order to reduce power consumption, the wakeup duration of the UE is minimized or reduced. As a result, inter frequency measurements during the short wake-up period of the UE are limited. In some instances, the UE performs inter frequency measurements according to a round robin implementation, as illustrated in FIG. 5.

FIG. 5 illustrates an inter frequency measurement and decoding implementation of a serving cell/RAT during a DRX cycle 500. In this example, the DRX cycle may span a period corresponding to three 5 ms subframes 502, 504 and 506. Each of the subframes 502, 504 and 506 may include seven time slots, TS0 through TS6. In each DRX cycle 500, the UE periodically monitors the communication channel for messages (e.g., paging messages or signals transmitted by a base station) and to measure the serving cell. For example, the UE may wake up at time 508 that corresponds to a start of the DRX cycle 500. During the first subframe 502 of the DRX cycle 500, the UE may perform cell reacquisition and intra-frequency measurement. The cell reacquisition and intra-frequency measurement may be initiated at the wake up time 508. The cell reacquisition and some portions of the intra-frequency measurement may be implemented in one or more time slots (e.g., time slot TS0.) The UE may initiate paging indicator channel (PICH) decoding at time 510 and initiate IRAT measurement at time 512. The IRAT measurement may include measurement of communication parameters, such as global system for mobile communications (GSM) received signal strength indicator (RSSI) based on a timer, such as TmeasureGSM timer.

During the second subframe 504 of the DRX cycle 500, the UE may initiate inter frequency measurement at time 514. The UE may also initiate inter RAT measurement at time 516. The inter frequency measurement may be initiated at the start of the second subframe 504 and performed during one or more time slots (e.g., TS0) of the second subframe 504. During the third subframe 506 of the DRX cycle 500, the UE may initiate cell evaluation and BSIC identification at time 518. The UE may perform the cell evaluation every DRX cycle before going to sleep at time 520.

In current implementations, when multiple inter frequency neighbors are broadcast, the UE cycles through all frequencies according to a round robin implementation. The UE measures one frequency (for inter frequency analysis) every DRX cycle according to the round robin implementation. For example, the UE measures a first frequency, F1, during a first DRX cycle, and then measures a second frequency, F2, during a second DRX cycle and so on.

In some instances, an operation may cause a UE to reselect to a neighbor cell at a different frequency from a current serving cell. For example, the UE may be caused to reselect when the UE is on a fast moving highway or underneath a tunnel. The cell reselection may be controlled by an offset value (e.g., Qoffset) for each of the neighbor cells. The offset value for each neighbor cell may be indicated and broadcast by the network (e.g., a base station of the network.)

The offset value, Qoffset, may be used to calculate a neighbor cell rank. If a neighbor cell rank is higher than the serving cell rank, the higher ranking neighbor cell is reselected. In some implementations, the highest ranking neighbor cell may be the target cell for cell reselection.

Qoffset can be set from −50 to +50 dB. In some implementations, the serving cell rank may be calculated as follows:

Rank_{—}s=RSCP+Qhyst

where Rank_s is the serving cell rank; RSCP is a received signal code power and Qhyst is a hysteresis parameter

The neighbor cell rank may be calculated as follows:

Rank_{—}n=RSCP−Qoffset

where Rank_n is the neighbor cell rank; RSCP is a received signal code power and Qoffset is an offset value

Neighbor cells in a TD-SCDMA network are typically on different frequencies due to N-frequency cell deployment in TD-SCDMA. The round robin implementation of inter frequency measurement scheduling may delay reselection of a UE to a preferred neighbor cell. Under certain circumstances, the DRX cycle is 1.28 seconds and there are nine inter frequency neighbor cells, F1, F2, . . . , F9. If the preferred neighbor cell is on frequency, F9, the UE measures frequency, F9, after about 10 DRX cycles. The delay associated with the measurement of the preferred neighbor cell frequency, F9, is given by, 10*1.28=12.8 seconds. This delay may cause a cell reselection failure, which causes missed paging or call failure during a period of the reselection failure.

In aspects of the present disclosure, if all of the inter frequency neighbor cells have the same offset value (e.g., Qoffset value), the UE schedules inter frequency measurement via the round robin implementation. However, if the inter frequency neighbor cells have different Qoffset values, the UE schedules inter frequency measurements based on the Qoffset values instead of in a round robin implementation.

In one aspect of the disclosure, the lower the Qoffset value for a neighbor cell, the earlier the UE schedules measurement of that neighbor cell during the short wake-up period of the UE. Further, the UE may schedule measurement of a neighbor cell with a lower Qoffset value more frequently. The proposed method may effectively avoid or reduce delay associated with measuring preferred neighbor cells by a UE, thus preventing missed paging, and call failures for certain network scenario.

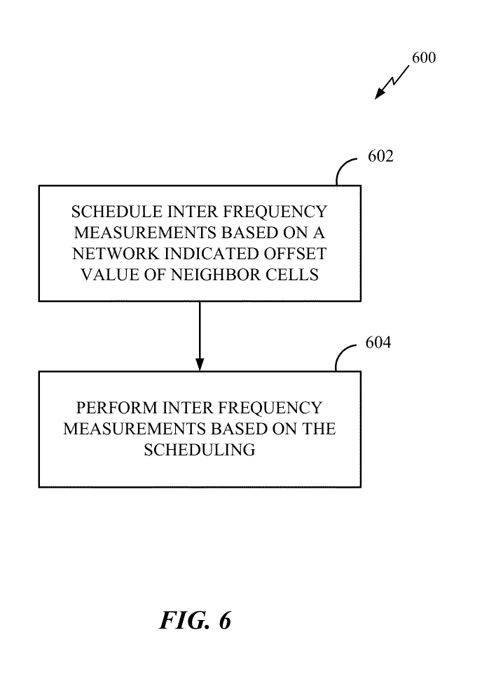

FIG. 6 is a block diagram illustrating an inter frequency measurement method 600 for discontinuous reception mode according to one aspect of the present disclosure. As shown in FIG. 6 a UE may schedule inter frequency measurements based on a network indicated offset value (e.g., Qoffset) of neighbor cells, as shown in block 602. A UE may perform measurements based on the scheduling, as shown in block 604. The measurements may be performed when the user equipment (UE) wakes up from a sleep mode.

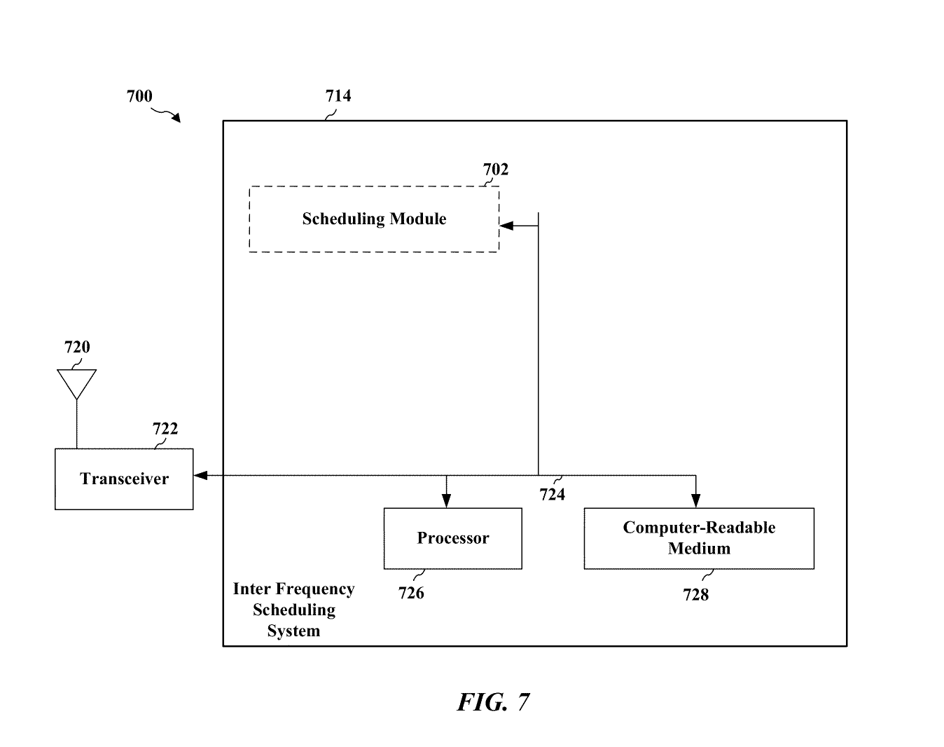

FIG. 7 is a diagram illustrating an example of a hardware implementation for an apparatus 700 employing an inter frequency scheduling system 714. The inter frequency scheduling system 714 may be implemented with a bus architecture, represented generally by a bus 724. The bus 724 may include any number of interconnecting buses and bridges depending on the specific application of the inter frequency scheduling system 714 and the overall design constraints. The bus 724 links together various circuits including one or more processors and/or hardware modules, represented by a processor 726, a scheduling module 702, and a computer-readable medium 728. The bus 724 may also link various other circuits such as timing sources, peripherals, voltage regulators, and power management circuits, which are well known in the art, and therefore, will not be described any further.

The apparatus includes the inter frequency scheduling system 714 coupled to a transceiver 722. The transceiver 722 is coupled to one or more antennas 720. The transceiver 722 provides a means for communicating with various other apparatus over a transmission medium. The inter frequency scheduling system 714 includes the processor 726 coupled to the computer-readable medium 728. The processor 726 is responsible for general processing, including the execution of software stored on the computer-readable medium 728. The software, when executed by the processor 726, causes the inter frequency scheduling system 714 to perform the various functions described supra for any particular apparatus. The computer-readable medium 728 may also be used for storing data that is manipulated by the processor 726 when executing software.

The inter frequency scheduling system 714 further includes the scheduling module 702 for scheduling inter frequency measurements based on a network indicated offset value of neighbor cells. The scheduling module 702 may be a software module running in the processor 726, resident/stored in the computer-readable medium 728, one or more hardware modules coupled to the processor 726, or some combination thereof. The inter frequency scheduling system 714 may be a component of the UE 350 and may include the memory 392 and/or the processor 390.

In one configuration, the apparatus 700 for wireless communication includes means for scheduling. The means may be the scheduling module 702, the inter frequency measurement module 391, the memory 392, the processor 390 and/or the inter frequency scheduling system 714 of the apparatus 700 configured to perform the functions recited by the measuring and recording means. As described above, the inter frequency scheduling system 714 may include the memory 392 and/or the processor 390. In another aspect, the aforementioned means may be any module or any apparatus configured to perform the functions recited by the aforementioned means.

In one configuration, the apparatus 700 for wireless communication includes means for performing. The means may be the inter frequency measurement module 391, antenna 352, receiver 354, receive processor, the memory 392, the processor 390 and/or the inter frequency scheduling system 714 of the apparatus 700 configured to perform the functions recited by the means. As described above, the inter frequency scheduling system 714 may include the memory 392 and/or the processor 390. In another aspect, the aforementioned means may be any module or any apparatus configured to perform the functions recited by the aforementioned means.

Several aspects of a telecommunications system has been presented with reference to TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
scheduling inter frequency measurements based at least in part on a network indicated offset value of neighbor cells.

2. The method of claim 1, further comprising, performing measurements when a user equipment (UE) wakes up from a sleep mode.

3. The method of claim 1, further comprising scheduling measurement of a neighbor cell with a lower offset value more frequently and/or scheduling measurement of a neighbor cell with a higher offset value less frequently.

4. The method of claim 1, further comprising scheduling measurement of a neighbor cell with a lower offset value earlier and/or scheduling measurement of a neighbor cell with a higher offset value later.

5. The method of claim 1, in which the offset value for each neighbor cell comprises a Qoffset value.

6. An apparatus for wireless communication, comprising:
means for scheduling inter frequency measurements based at least in part on a network indicated offset value of neighbor cells; and
means for performing inter frequency measurements based at least in part on the scheduling.

7. The apparatus of claim 6, in which the performing means further comprises means for performing inter frequency measurements when a user equipment (UE) wakes up from a sleep mode.

8. The apparatus of claim 6, in which the scheduling means further comprises means for scheduling measurement of a neighbor cell with a lower offset value more frequently and/or means for scheduling measurement of a neighbor cell with a higher offset value less frequently.

9. The apparatus of claim 6, in which the scheduling means further comprises means for scheduling measurement of a neighbor cell with a lower offset value earlier and/or means for scheduling measurement of a neighbor cell with a higher offset value later.

10. The apparatus of claim 6, in which the offset value for each neighbor cell comprises a Qoffset value.

11. An apparatus for wireless communication, comprising:
a memory; and
at least one processor coupled to the memory and configured:
to schedule inter frequency measurements based at least in part on a network indicated offset value of neighbor cells.

12. The apparatus of claim 11, in which the at least one processor is further configured to perform measurements when a user equipment (UE) wakes up from a sleep mode.

13. The apparatus of claim 11, in which the at least one processor is further configured to schedule measurement of a neighbor cell with a lower offset value more frequently and/or to schedule measurement of a neighbor cell with a higher offset value less frequently.

14. The apparatus of claim 11, in which the at least one processor is further configured to schedule measurement of a neighbor cell with a lower offset value earlier and/or to schedule measurement of a neighbor cell with a higher offset value later.

15. The apparatus of claim 11, in which the offset value for each neighbor cell comprises a Qoffset value.

16. A computer program product for wireless communications in a wireless network, comprising:
a non-transitory computer-readable medium having program code recorded thereon, the program code comprising: program code to schedule inter frequency measurements based at least in part on a network indicated offset value of neighbor cells.

17. The computer program product of claim 16, in which the program code further comprises program code to perform measurements when a user equipment (UE) wakes up from a sleep mode.

18. The computer program product of claim 16, in which the program code to schedule further comprises program code to schedule measurement of a neighbor cell with a lower offset value more frequently and/or to schedule measurement of a neighbor cell with a higher offset value less frequently.

19. The computer program product of claim 16, in which the program code to schedule further comprises program code to schedule measurement of a neighbor cell with a lower offset value earlier and/or to schedule measurement of a neighbor cell with a higher offset value later.

20. The computer program product of claim 16, in which the offset value for each neighbor cell comprises a Qoffset value.
